(19) United States
(12) Patent Application Publication
(10) Pub. No.: US 2001/0015294 A1
(43) Pub. Date: Aug. 23, 2001

(54) Writing tablet with a script input surface

(75) Inventors: Rene Baltus, Bonn (DE); Marc-Bernd Woop, Bonn (DE)

Correspondence Address: THE FIRM OF KARL F ROSS, 5676 RIVERDALE AVENUE, PO BOX 900, RIVERDALE (BRONX), NY, 10471-0900, US

(73) Assignee: Rene BALTUS

(21) Appl. No.: 09/739,038

(22) Filed: Dec. 18, 2000

(30) Foreign Application Priority Data
Dec. 19, 1999 (DE) 19961357.5

(51) Int. Cl. G06K 11/18; G08C 21/00

(52) U.S. Cl. 178/19.01

(57) ABSTRACT

A writing tablet for allowing handwritten material on paper form in which the script input surface which electronically digitize the script, is marked by illumination to allow proper alignment of the document to receive the script.

### FIELD OF THE INVENTION

Our present invention relates to a writing tablet with a script input surface, particularly for providing an input to a computer, in which the script input surface forms a portion of the form which is to be inscribed on the tablet and a document in the form of a sheet of paper is adapted to overly the script input surface and to cover the latter.

### BACKGROUND OF THE INVENTION

A writing tablet for inputting digitized information corresponding to a document into a computer can have a support surface for the document which can be in the form of a sheet of paper on which hand writing is to be applied, for example a signature. With the increasing use of computer forms and handwritten signatures to such forms, electromechanical devices have been developed for storing in the computer or transmitting to the computer some indication of the handwritten material which can be subsequently verified or which can have legal effect. Apparatus of this type digitizes the inputted information including the handwriting and the digitized information can include data of a form type to which the digitized signature or script is added.

An electromechanical system for detecting the handwriting dynamics is described in EP 0 560 356. This system provides a plate floating on load cells so that the writing dynamic applied by conventional writing tools can be detected in a four dimensional manner.

A drawback of this process is that when the paper document or form is to be subscribed at a specific location, the alignment of the paper form with the device presents a problem since, for signature recognition and validity purposes, it is essential that the signature space be exactly located on the device. That means that extreme care must be taken in alignment of the document on the script input surface so that the signature is properly positioned thereon and the writing pressure of the tool can be digitized as the input to the computer.

When a stop is provided at a right angle to the support surface for positioning the document, the document can be located with precision on the script input surface, but the stop can only be suitable for a particular document or form type. Documents of other formats and sizes cannot be effectively aligned or positioned as to the script input surface with the aid of such stops.

### OBJECTS OF THE INVENTION

It is the principal object of the present invention to provide an improved writing tablet in which accurate positioning of a document with respect to the script input surface can be achieved, regardless of the document size, format or layout.

Another object of this invention is to obviate the drawbacks of earlier systems as have been described.

### SUMMARY OF THE INVENTION

These objects and other which will come apparent hereinafter are attained, in accordance with the invention in a writing tablet which comprises:

a paper-support surface for receiving a document and formed with a script input surface forming at least part of the support surface and overlain by the document at a region thereof receiving a handwritten inscription for producing the input when a writing tool handwrites the region over the script input surface; and

means including at least one light source and forming at least one illumination field transluminating the document and marking out by illumination the script input surface.

The writing tablet of the invention is intended as a peripheral to a computer for providing an input representing at least the hand inscribed text of a document placed upon the supporting surface and to that extent can also be referred to as digitizer.

Basically, according to the invention, in, below, and/or laterally of the script input surface, at least one light field, especially a light source, is arranged which passes light through the sheet or document, i.e. transluminates it and thereby optically marks the script input surface.

The tablet and/or the script input surface therefore is provided with at least one illuminated marking by means of which the paper sheet or document to be inscribed by handwriting, for example a signature, can be aligned with certainty with respect to the script input surface and the inscription effort substantially simplified. The inscription can be applied to the script input surface (provided with the means for digitizing the inscription pressure) with a high degree of reliability.

According to a feature of the invention the light field or fields and especially the light source or sources can be point shaped, line shaped and/or of laminar shape (planar and covering an area). The light field or light fields and especially the light source or sources can be arranged at least along one edge of the script input surface, preferably linearly along a lower edge thereof or as a signature line. The light field or light fields and the light source or light sources can surround the script input surface in a frame pattern and the light can pass through a gap between the script input surface and the paper support surface adjacent the script input surface.

Illumination should mark at least two corners of the script input surface and either the entire script input surface or the entire paper support surface surrounding the script input surface can be an illuminated field. The lighting can be turned on only for the period in which the writing is to be carried out and can be turned on by the commencement of the writing operation. As noted, the writing usually involves signature to the document.

The script input surface can be smaller than the form and the writing instrument used can generate pressure upon this surface which can measure the pressure and supply a digitized input to the computer representing the script pattern. The document, in the form of a sheet of paper is placed upon the support surface and based upon the illumination field which transluminates the document, the signature space, line or any location requiring handwriting is clearly visible and the document can be then accurately positioned.

### BRIEF DESCRIPTION OF THE DRAWING

The above and other objects, features, and advantages will become more readily apparent from the following description, reference being made to the accompanying drawing in which:

FIG. 1 is a diagrammatic perspective view showing a writing tablet according to the invention connected to the computer;

FIG. 2 is a fragmentary perspective view of a portion of a writing tablet showing another feature; and

FIG. 3 is a cross sectional view illustrating yet another aspect of the invention.

### SPECIFIC DESCRIPTION

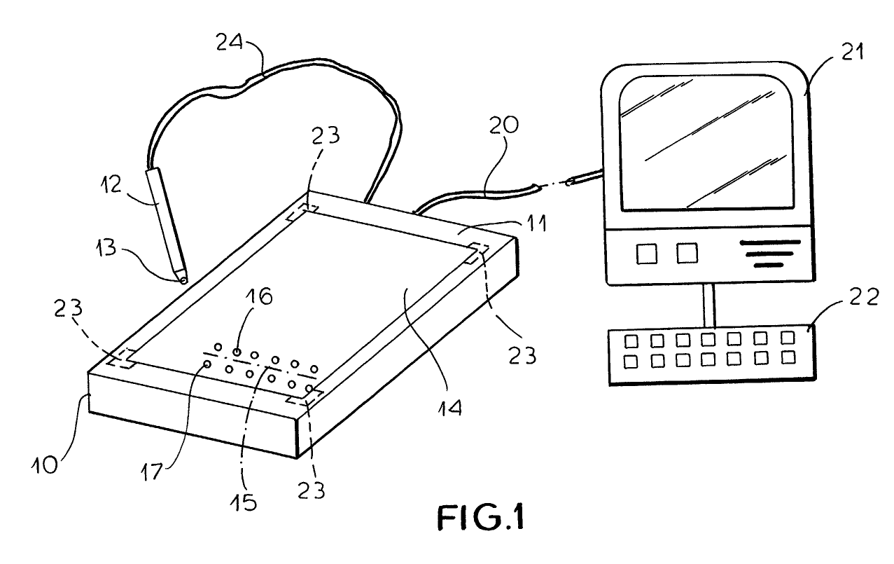

In FIG. 1 a writing tablet 10 has been shown in which a paper support surface 11 can be provided with a writing tool 12 which can include a ball point pen 13 enabling signature of a document 14 along a signature space represented by the dot-dash line. On the support surface, there is a script input surface framed by rows 16 and 17 of punctiform light sources, for example, LEDs, which allow the signature line to be accurately placed on the script input surface so that, with signature of the document using the pen 12, 13, a written signature is applied to the document and at the same time the signature pressure is digitized and connected via the line 20 to the computer 21 which may have a keyboard 22 controlling storage of the document with the signature. If desired, illumination fields can be provided at 23 corresponding to the corners of the document as well. The pen 12, 13, is wired at 24 to the tablet so that the marking lights are illuminated when the pen is taken in hand to sign the document.

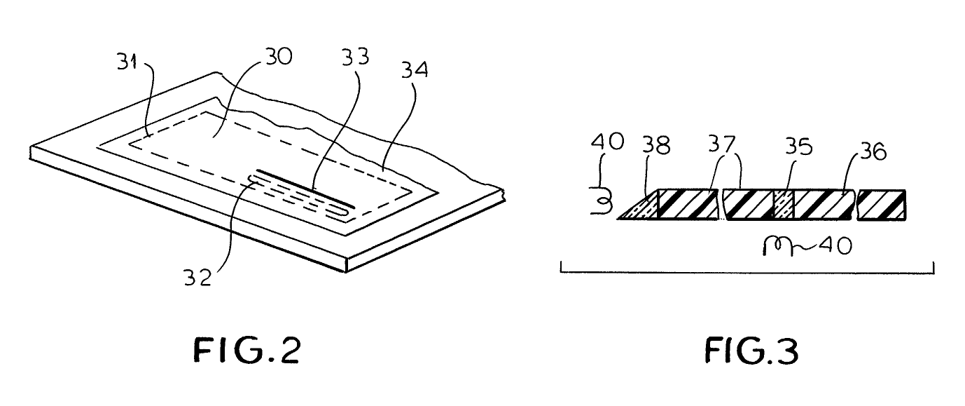

As can be seen from FIG. 2, the script input surface 30 can be demarcated by lights 31 completely framing out the script input surface and even including at least one row of lamps 32 directly below or along the signature line 33 on the document 34. The illuminated fields can include a region 35 in a gap between the script input surface 36 and the balance of the paper support surface 37 (FIG. 3) or by illumination of an edge at 38. The illuminating means has symbolically been shown by the lamp 40. Thus in one embodiment, one or more light sources can be arranged below the paper support surface, which may be transparent, or in a gap which is transparent between a housing and the freely supported writing tablet. The script field is thus provided with a crown of lighting which passes through the paper, delineates the boundaries of the writing surfaces and effective orientation. As noted, see especially FIG. 3) it is advantageous to provide throughgoing slots in the support plate which can be filled with transparent material and can conduct the light from below the support plate to the surface. The slots can be of greater thickness to represent boundaries of the writing field and of lesser thickness to represent the signature line or vice versa.

The writing field may be simply a bounded region of the support plate. or a region separated from the support plate by a gap at a certain distance from the edge of the support plate and connected thereto at only locations sufficient to maintain integrity. The signature line can then be a wider gap so as to be easily recognizable. This has the advantage that the writer will not carry the script to the end of the paper support surface which could be detrimental to recognition of the signature.

The support plate can be composed of transparent material and the light sources located below or laterally thereof. The boundaries of the support plate can be darkened or masked and that has been found to help distinguish the writing field, which is brighter, from the remainder. The signature line may always be more strongly illuminated to facilitate signature.

The paper support surface can be composed of an acrylic resin and various markings can be engraved or molded into the plate to permit the writing and boundary lines to be more clearly distinguishable.

If the sides of the writing plate are bevelled at 45° to the light source access and the bevels are mirrored, these can serve as visible light crowns on three or four sides.

The features described permit unlined papers to be used to receive script in an esthetic way and the invention is applicable to any kind of form which can be electronically stored but must be signed by hand. The result is an electronically authenticated as well as a paper authenticated document which will satisfy all juridical needs.

We claim:

1. A writing tablet for providing an input to a computer, comprising:
a paper-support surface for receiving a document and formed with a script input surface forming at least part of said support surface and overlain by said document at a region thereof receiving a handwritten inscription for producing said input when a writing tool handwrites said region over said script input surface; and
means including at least one light source and forming at least one illumination field transluminating said document and marking out by illumination said script input surface.

2. The writing tablet defined in claim 1 wherein said illumination field is in said script input surface.

3. The writing tablet defined in claim 1 wherein said illumination field is below said script input surface.

4. The writing tablet defined in claim 1 wherein said illumination field is laterally of said script input surface.

5. The writing tablet defined in claim 1 wherein said illumination field is a punctiform field.

6. The writing tablet defined in claim 1 wherein said illumination field is a linear field.

7. The writing tablet defined in claim 1 wherein said illumination field is a laminar field.

8. The writing tablet defined in claim 1 wherein said illumination field extends at least along one edge of said script input surface.

9. The writing tablet defined in claim 1 wherein said illumination field forms a frame around said script input surface.

10. The writing tablet defined in claim 1 wherein said illumination field is formed by light passing through a gap between said script input surface and a part of said support surface neighboring same.

11. The writing tablet defined in claim 1 wherein said illumination field is formed by light marking out at least two corners of said script input surface.

12. The writing tablet defined in claim 1 wherein said illumination field is formed over an area of said script input surface.

13. The writing tablet defined in claim 1 wherein said illumination field is formed over an area of said support surface surrounding said script input surface.

14. The writing tablet defined in claim 1 wherein said field is activated at a time when a writing tool handwrites said region over said script input surface.

15. The writing tablet defined in claim 14 wherein the handwriting in said region is a signature.
